(19) United States
(12) Patent Application Publication
(10) Pub. No.: US 2007/0240377 A1
(43) Pub. Date: Oct. 18, 2007

(54) Traffic Light With Modular Pole

(76) Inventor: Barry Geer, Johannesburg (ZA)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,309

(22) PCT Filed: Dec. 8, 2004
(86) PCT No.: PCT/IB04/52715

§ 371 Date: Feb. 22, 2007

(30) Foreign Application Priority Data
Dec. 8, 2003 (ZA) 2003/9422

(51) Int. Cl. E04H 12/18; G08G 1/095

(52) U.S. Cl. 52/632; 340/907

(57) ABSTRACT

This invention relates to a light assembly and more particularly, to a modular traffic light assembly. A light assembly comprising a pole having a plurality of inter-engagable sections located end-to-end to form the pole and a light attached at an operatively upper end of the pole.

### FIELD OF THE INVENTION

This invention relates to a light assembly and more particularly, to a modular traffic light assembly.

### BACKGROUND TO THE INVENTION

Traffic light assemblies are used in urban areas to control the flow of traffic at road intersections or pedestrian crossings. Conventional traffic light assemblies includes a pole in the form of a hollow integrally formed pipe and at least one light assembly secured at the top of the pole. Each light assembly includes separate lights of two or three different colours.

The operation of traffic light assemblies may be compromised in various ways such as for example a failure of light bulbs or disruption of electrical contact between the traffic light and source of electrical power. Traffic light assemblies may also be run over by motor vehicles.

In repairing a conventional traffic light, which was run over by a motor vehicle, the integrally formed pole is replaced, often at a large cost. Such replacement may also be time consuming.

When a light of a conventional traffic light assembly is faulty, the head panel is normally removed, the fault traced and the repairs then made, whereafter the head panel is re-assembled and attached to the pole. This procedure may be time consuming.

Dysfunctional traffic light assemblies often cause substantial traffic jams resulting in a loss of productive time of economically active people. It is therefore critical that faulty traffic light assemblies be repaired speedily and cost effectively.

### OBJECT OF THE INVENTION

It is an object of this invention to provide a light assembly which, at least partially, alleviates some of the disadvantages associated with certain prior art.

### SUMMARY OF THE INVENTION

A light assembly comprising a pole having a plurality of inter-engagable sections located end-to-end to form the pole and a light attached at an operatively upper end of the pole.

The pole includes a light connector at an upper end thereof.

A footpiece is engaged underneath an operatively lowest section of the pole.

The footpiece has an operatively lower outwardly extending skirt providing a wider base section for supporting the pole.

The inter-engagable sections are cylindrical and have complementary neck and collar formations on one end and complementary shaped first inner blind bores for receiving the neck of an adjacent section.

The inter-connectable sections have second bores therethrough so that the assembled pole includes a passage therethrough.

A securing line is located through the passage to be tightened in an axial direction at one or both ends to secure the sections of the pole together.

The securing line is a rod having screw threaded ends for receiving nuts for securing the sections together.

The light connector includes lip formations, one lip formation extending upwardly from a base thereof and the other downwardly form operatively upper end of a cylindrical section to form downwardly and upwardly facing channel sections for receiving lugs at the rear of a traffic light therein.

A light is securable at any position about the cylindrical section.

The base and cylindrical section are axially movable relative to each other to move the lip formations away from each other to facilitate insertion of lugs at the rear of a light in the opposing channels formed by the lip formations.

An adaptor is connectable to the light connector, the adaptor having a number of sockets for receiving lights in the sockets.

A light connected to the pole includes a bank of light emitting diodes.

The bank of light emitting diodes is controlled to emit one of a plurality of different colours of light at a time.

Groups of light emitting diodes in the bank can be switched off while the remaining light emitting diodes are switched on to form a shape in the bank of light emitting diodes formed by the light emitting diodes remaining switched on.

The light assembly may be a traffic light assembly.

### BRIEF DESCRIPTION OF THE DRAWINGS

Preferred embodiments of the invention are described below, by way of example only, and with reference to the accompanying drawings, in which:

FIG. 1 shows a perspective exploded view of a light assembly including a pole and a light;

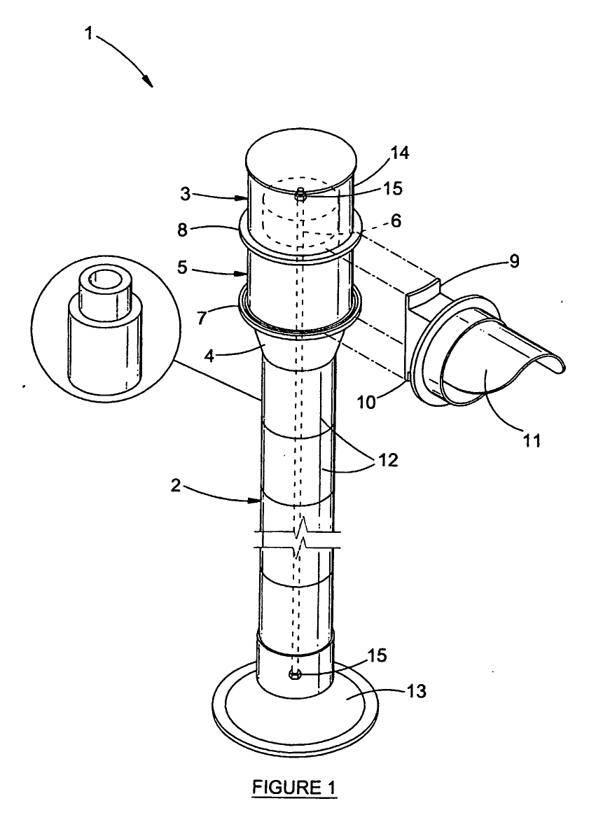

FIG. 2 shows a perspective view of the light assembly of FIG. 1;

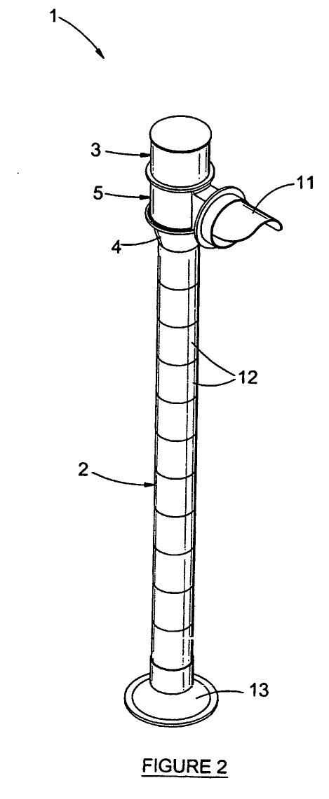

FIG. 3 shows a top plan view of a second embodiment of a light assembly;

FIGS. 4a and 4b show perspective views of an adaptor for connecting a plurality of traffic lights to a traffic pole; and

FIG. 5 shows an exploded view of a third embodiment of a light assembly.

### DETAILED DESCRIPTION OF THE DRAWINGS

With reference to the drawings, a light assembly is generally indicated by reference numeral 1.

The light assembly 1 includes a pole 2 and a connector or head 3, which is connected to, on or in the pole. The connector 3 includes a base section 4, a cylindrical section 5 and securing means 6 for securing the connector 3 to the base 4. The base 4 and connector 3 have holding means 7 and 8 in the form of annular lips for holding a light on the cylindrical section 5 when the connector 5 is secured to the base 4. In this embodiment, the light assembly is a traffic light assembly.

The base 4 and cylindrical section are both circular in cross section and arranged coaxially to the axis of the pole.

As stated above, the holding means 7 and 8 are lip formations in the form of circular channels extending from the circumference of the base 4 and upper end of the cylindrical section 5 and arranged about the axis of the pole 2 to terminate in lip formations upwardly extending from the base 4, and downwardly from the upper end of the cylindrical section, for receiving complementary lugs 9 and 10 located at a rear end of a traffic light 11 therein.

The pole 2 is made up of a plurality of cylindrical pole sections 12 which sections are interconnectable or engagable by means of a complementary neck and collar formations, to erect the pole. Each section thus has a neck and collar formation at one end and an inner blind first bore at the other end to receive a complementary neck. Each of the sections 12 has a second axially extending bore therethrough such that when erected, the pole 2 has a passage therethrough, which passage extends coaxially with the pole. The second bore diameter is smaller that that of the first bore.

The traffic light assembly 1 has a foot 13 for supporting the pole 2 in an upright position. An upper end of the foot 13 terminates in a neck and collar formation (or annular rebate) so that the neck extends into the bore of the lower-most section 12 of the pole. The lower end of the foot terminates in an outwardly extending skirt to provide a wider base section for supporting the pole.

The connector 3 includes a default light 14, for in use indicating the failure of a traffic light 11 of the traffic light assembly.

The cap securing means 6 includes a bar or rod, which has two threaded ends for receiving threaded nuts 15 thereon. The bar extends through the passage, from the foot to the top of the pole and secures the head, foot and sections of the pole together. The sections may be of alternating yellow and black, or any other, colours.

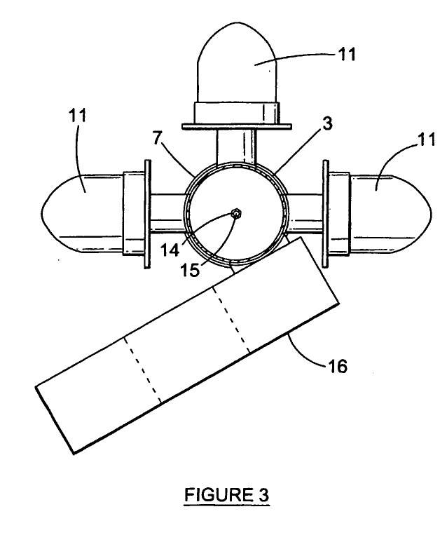

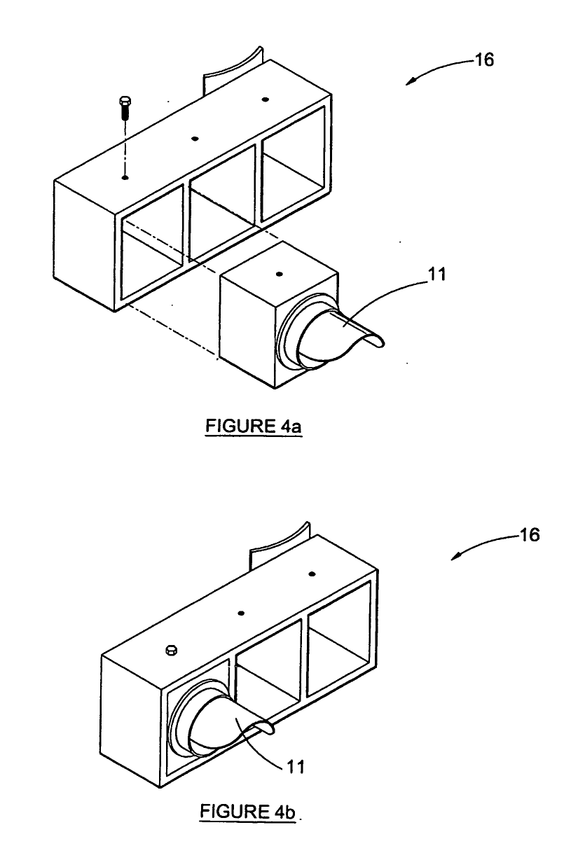

The traffic light assembly as shown in FIG. 3 includes an adaptor 16 (also shown in FIGS. 4a and 4b) connected to the top of the pole. The adaptor 16 has a plurality of sockets for receiving a plurality of traffic lights 11 therein. As shown in FIG. 3, a number of lights 11 can be located on the cylindrical section 5. An adaptor can also be located on the cylindrical section 5 for receiving even more lights in its sockets. The longitudinal axis of the adaptor can extend vertically or horizontally. Lights and the adaptor may be secured at any position about the cylindrical section 5.

Each traffic light 11 includes a bank of light emitting diodes (LEDs). These diodes may be of the type being able to emit different wavelengths so as to selectively emit light of different colour. Each of these lights are controlled to emit green, red or amber light at any given time, as described. This obviates the need to have 3 different lights. One light (bank of LEDs) can now be used to selectively emit one of three different colours at a time. The LEDs can also be controlled to show different shapes. Green, red and amber lights may be shown in different shapes so that a colour blind person may distinguish between the different colours shown by looking at the shape formed by those LEDs lit at the same time. The shapes are achieved by powering up only a selected group of the LEDs in the bank of LEDs. Many shapes or figures may be shown in this way. Arrows and other traffic signals may also be shown in this way.

The use of LEDs is also more cost effective than other lights. This also allows for the ease of use of back-up batteries as such lights use less energy thus extending battery life.

In use, the traffic light assembly will be assembled by erecting the pole and securing the pole head and foot together by means of the rod that runs through the passage and securing means at either end of the rod. The default light indicates failure of a traffic light.

A faulty traffic light is replaced by loosening either of the nuts on the securing means or the foot, spacing the holding means apart by moving the base away from the cylindrical section (which are two separate sections) and replacing the damaged light with a replacement light. It is envisaged that this repair procedure would result in a saving of cost and time. In an alternative embodiment, the cylindrical section may have an outer sleeve at the top end of which is located the upper lip formation. The sleeve may be slidably movable over the cylindrical section so that the two lip formations may be spaced apart to facilitate insertion in the channels formed by the lip formations, of the lugs at the rear of a light.

Electrical connectors may be provided on and about the cylindrical section for connecting lights thereto. Electrical cabling may be alternatively be provided through the passage and through radially extending holes in the sections or through the top end or cylindrical section of the pole.

Damage to the pole may be repaired by merely replacing those sections 12 of the pole, which was actually damaged, thus saving costs.

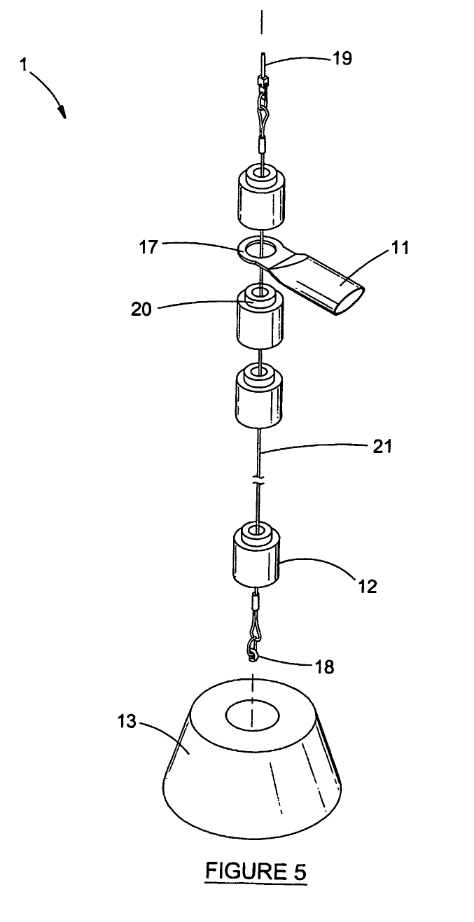

The light assemblies may be also configured as shown in the embodiment of FIG. 5. The lights 11 may be generally cylindrical at one end and have a flat plate 17 at the other end. The plate 17 has a hole therethrough so that a neck 20 of one of the sections 12 fits snugly through the hole. In this embodiment, the assembly is held together with a cable 21 that terminates in loop sections which are attached to complementary loop formations having threaded rods on their outsides (18 and 19) for tightening the cable in the passage of the pole.

The invention is not limited to the precise elements as described herein. For example, the securing means may also include a cable, chain or rope. The sections of the pole may be inter-connectable by means of overlapping portions secured together by means of screws.

1. A light assembly comprising a pole having a plurality of inter-engagable sections located end-to-end to form the pole and a light attached at an operatively upper end of the pole.

2. A light assembly as claimed in claim 1 in which the pole includes a light connector at an upper end thereof.

3. A light assembly as claimed in claim 1 further comprising a footpiece is engaged underneath an operatively lowest section of the pole.

4. A light assembly as claimed in claim 3 in which the footpiece has an operatively lower outwardly extending skirt providing a wider base section for supporting the pole.

5. A light assembly as claimed in claim 1 wherein the inter-engagable sections are cylindrical and have complementary neck and collar formations on one end and complementary shaped first inner blind bores for receiving the neck of an adjacent section.

6. A light assembly as claimed in claim 1 wherein the interconnectable sections have second bores therethrough so that the assembled pole includes a passage therethrough.

7. A light assembly as claimed in claim 6 in which a securing line is located through the passage and secured at at least one end and to be tightened in an axial direction at one or both ends to secure the sections of the pole together.

8. A light assembly as claimed in claim 7 in which the securing line is a rod having screw threaded ends for receiving nuts for securing the sections together.

9. A light assembly as claimed in claim 8 wherein the light connector includes lip formations, one lip formation extending upwardly from a base thereof and the other downwardly form an operatively upper end of a cylindrical section to form downwardly and upwardly facing channel sections for receiving lugs at the rear of a traffic light therein.

10. A light assembly as claimed in claim 9 in which a light is securable at any position about the cylindrical section.

11. A light assembly as claimed in claim 10 the base and cylindrical section are axially movable relative to each other to move the lip formations away from each other to facilitate insertion of lugs at the rear of a light in the opposing channels formed by the lip formations.

12. A light assembly as claimed in claim 2 further comprising an adaptor is connectable to the light connector, the adaptor having a number of sockets for receiving lights in the sockets.

13. A light assembly as claimed in a claim 1 wherein the light connected to the pole includes a bank of light emitting diodes.

14. A light as claimed in claim 13 in which the bank of light emitting diodes is controlled to emit one of a plurality of different colours of light at a time.

15. A light assembly as claimed in claim 13 wherein groups of light emitting diodes in the bank can be switched off while the remaining light emitting diodes are switched on to form a shape in the bank of light emitting diodes formed by the light emitting diodes remaining switched on.

16. A light assembly as claimed in claim 1 wherein the light assembly is a traffic light assembly.
